(19) United States
(12) Patent Application Publication
(10) Pub. No.: US 2016/0361650 A1
(43) Pub. Date: Dec. 15, 2016

(54) GAME PROGRAM, GAME DEVICE, AND GAME CONTROL METHOD

(71) Applicant: KONAMI DIGITAL ENTERTAINMENT CO., LTD., Tokyo (JP)

(72) Inventors: Keishi TERAO, Tokyo (JP); Risa SEKINE, Tokyo (JP); Hiroaki TAKAHASHI, Tokyo (JP); Eriko MOTOHASHI, Tokyo (JP)

(73) Assignee: KONAMI DIGITAL ENTERTAINMENT CO., LTD., Tokyo (JP)

(21) Appl. No.: 15/246,697

(22) Filed: Aug. 25, 2016

Related U.S. Application Data
(63) Continuation of application No. PCT/JP2015/055921, filed on Feb. 27, 2015.

(30) Foreign Application Priority Data
Feb. 28, 2014 (JP) 2014-039781

(51) Int. Cl. A63F 13/53; A63F 13/426; A63F 13/2145; A63F 13/25; A63F 13/44

(52) U.S. Cl. CPC A63F 13/53; A63F 13/25; A63F 13/44; A63F 13/2145; A63F 13/426

(57) ABSTRACT

A game program product includes a computer-readable program embodied on a non-transitory computer-readable storage medium. The computer-readable program, when executed by a computer, is to cause a computer to perform at least: controlling a display device to display a path indicator on a screen of the display device, the path indicator indicating a path on which a tracing operation should be made during a prescribed operating time period from a prescribed starting time until a prescribed ending time. Controlling the display device includes, but is not limited to, controlling the display device to gradually display the path indicator on the screen in accordance with a length of the prescribed operating time period.

### TECHNICAL FIELDS

The disclosure generally relates to a game program, a game device, and a game control method.

### BACKGROUNDS

Timing games are provided in which a determination is made regarding the success or failure of an operation made by a user with a timing that matches an indicator or the like displayed on a screen.

Japanese Patent No. 4691754 discloses such timing games includes, for example, ones in which a success/failure determination is made in accordance with the timing of a user operation made when an indicator that is displayed fixed on a screen is overlapped by an object moving toward the indicator, and ones in which display of a path indicator that is to be traced by an operation during a prescribed operation time period in step with a melody or the like is made and a success/failure determination in accordance with whether or not the operation to trace the path indicator has been made during the prescribed operation period is made.

In this case, when a success/failure determination is made in accordance with the timing of a user operation made when an indicator that is displayed fixed on a screen is overlapped by an object moving toward the indicator, the user can adjust the operation timing in accordance with the speed of movement of the object on the screen and the distance between the object and the indicator.

However, in the case of displaying a path indicator that is to be traced by an operation during a prescribed operation time period in step with a melody or the like and making a success/failure determination in accordance with whether or not the operation to trace the path indicator has been made during the prescribed operation time period, even if the path indicator is displayed until the timing of the start of the operation to be made, the user does not know the speed with which the operation with respect to the path indicator should be made, making it impossible to adjust the operation timing. Therefore, in timing games using such a path indicator, with the exception of a user who is accustomed, from playing the same game numerous times, to the timing and to what kind of path indicator will be displayed beforehand, enjoying the game is difficult. Given this, it is desirable to guide the user regarding the timing of the operation of the path indicator, thereby providing a timing game that can be enjoyed by a wide range of users.

### SUMMARY

A game program product may include, but is not limited to, a computer-readable program embodied on a non-transitory computer-readable storage medium. The computer-readable program, when executed by a computer, is to cause a computer to perform at least: controlling a display device to display a path indicator on a screen of the display device, the path indicator indicating a path on which a tracing operation should be made during a prescribed operating time period from a prescribed starting time until a prescribed ending time. Controlling the display device includes, but is not limited to, controlling the display device to gradually display the path indicator on the screen in accordance with a length of the prescribed operating time period.

### BRIEF DESCRIPTIONS OF THE DRAWINGS

FIG. 1 is a block diagram showing the constitution of a game device according to an embodiment of the present invention.

FIG. 2 shows an example of a game screen according to an embodiment of the present invention.

FIG. 3 is a first drawing showing the manner of shrinking of a surrounding object as it moves toward a second reference indicator according to an embodiment of the present invention.

FIG. 4 is a second drawing showing the manner of shrinking of a surrounding object as it moves toward a second reference indicator according to an embodiment of the present invention.

FIG. 5 is a third drawing showing the manner of shrinking of a surrounding object as it moves toward a second reference indicator according to an embodiment of the present invention.

FIG. 6 shows an example of the contents of sequence data according to an embodiment of the present invention.

FIG. 7 is a first example of a path indicator that is gradually displayed according to an embodiment of the present invention.

FIG. 8 is a second example of a path indicator that is gradually displayed according to an embodiment of the present invention.

FIG. 9 is a third example of a path indicator that is gradually displayed according to an embodiment of the present invention.

FIG. 10 is a flowchart showing an example of the operation by a game device according to an embodiment of the present invention.

FIG. 11 is a flowchart showing an example of the operation of the path indicator display processing by the game device according to an embodiment of the present invention.

FIG. 12 shows an example of a display of a path indicator according to an embodiment of the present invention.

FIG. 13 shows an example of a display at the first point in time, at which only the auxiliary indicator in the path indicator is displayed first according to an embodiment of the present invention.

FIG. 14 shows an example of a display at the second point in time, at which only the auxiliary indicator in the path indicator is displayed first according to an embodiment of the present invention.

FIG. 15 shows an example of a display at the third point in time, at which only the auxiliary indicator in the path indicator is displayed first according to an embodiment of the present invention.

FIG. 16 shows an example of a display at the fourth point in time, at which only the auxiliary indicator in the path indicator is displayed first according to an embodiment of the present invention.

FIG. 17 shows an example of a screen that displays a plurality of path indicators according to an embodiment of the present invention.

FIG. 18 is a block diagram showing an example of the constitution of a game system according to an embodiment of the present invention.

### DETAILED DESCRIPTIONS

### Embodiments

In some embodiment, a game program product may include, but is not limited to, a computer-readable program embodied on a non-transitory computer-readable storage medium. The computer-readable program, when executed by a computer, is to cause a computer to perform at least: controlling a display device to display a path indicator on a screen of the display device, the path indicator indicating a path on which a tracing operation should be made during a prescribed operating time period from a prescribed starting time until a prescribed ending time. Controlling the display device includes, but is not limited to, controlling the display device to gradually display the path indicator on the screen in accordance with a length of the prescribed operating time period.

In some cases, controlling the display device to gradually display the path indicator is started from an appearance time before the prescribed starting time.

In some cases, controlling the display device to display the path indicator may include, but is not limited to, controlling the display device to display the path indicator to gradually extend with a speed in accordance with the length of the prescribed operation time period, from a starting point of the path indicator to an ending point of the path indicator.

In some cases, controlling the display device to display the path indicator may include, but is not limited to, controlling the display device to display the path indicator gradually on the screen with such a speed that an elapsed time from the starting point to the ending point of the path indicator is the same as the prescribed operation time period. In some cases, the computer-readable program, when executed by a computer, is to cause a computer to perform further: accepting an operation with respect to the path indicator from a user; and determining whether the operation accepted is in success or failure.

In another embodiment, a game device may include, but is not limited to, circuitry configured to at least: control a display to gradually display a path indicator on a screen of the display device, the path indicator indicating a path on which a tracing operation should be made during a prescribed operating time period from a prescribed starting time until a prescribed ending time.

In some cases, the circuitry is configured to further at least: accept an operation with respect to the path indicator from a user; and determine whether the operation accepted by the acceptor is in success or failure.

In some cases, the circuitry is configured to start controlling the display device to gradually display the path indicator from an appearance time before the prescribed starting time.

In some cases, the circuitry is configured to control the display device to display the path indicator to gradually extend with a speed in accordance with the length of the prescribed operation time period, from a starting point of the path indicator to an ending point of the path indicator.

In some cases, the circuitry is configured to control the display device to display the path indicator gradually on the screen with such a speed that an elapsed time from the starting point to the ending point of the path indicator is the same as the prescribed operation time period.

In still another embodiment, a game system may include, but is not limited to, controlling, by a computer, a display to gradually display a path indicator on a screen of the display device, the path indicator indicating a path on which a tracing operation should be made during a prescribed operating time period from a prescribed starting time until a prescribed ending time; accepting, by a computer, an operation with respect to the path indicator from a user; and determining, by a computer, whether the operation accepted by the acceptor is in success or failure.

In some cases, controlling the display device to gradually display the path indicator is started from an appearance time before the prescribed starting time.

In some cases, controlling the display device to display the path indicator may include, but is not limited to, controlling the display device to display the path indicator to gradually extend with a speed in accordance with the length of the prescribed operation time period, from a starting point of the path indicator to an ending point of the path indicator.

In some cases, controlling the display device to display the path indicator may include, but is not limited to, controlling the display device to display the path indicator gradually on the screen with such a speed that an elapsed time from the starting point to the ending point of the path indicator is the same as the prescribed operation time period.

### First Embodiment

An embodiment of the present invention will be described, with references made to the drawings.

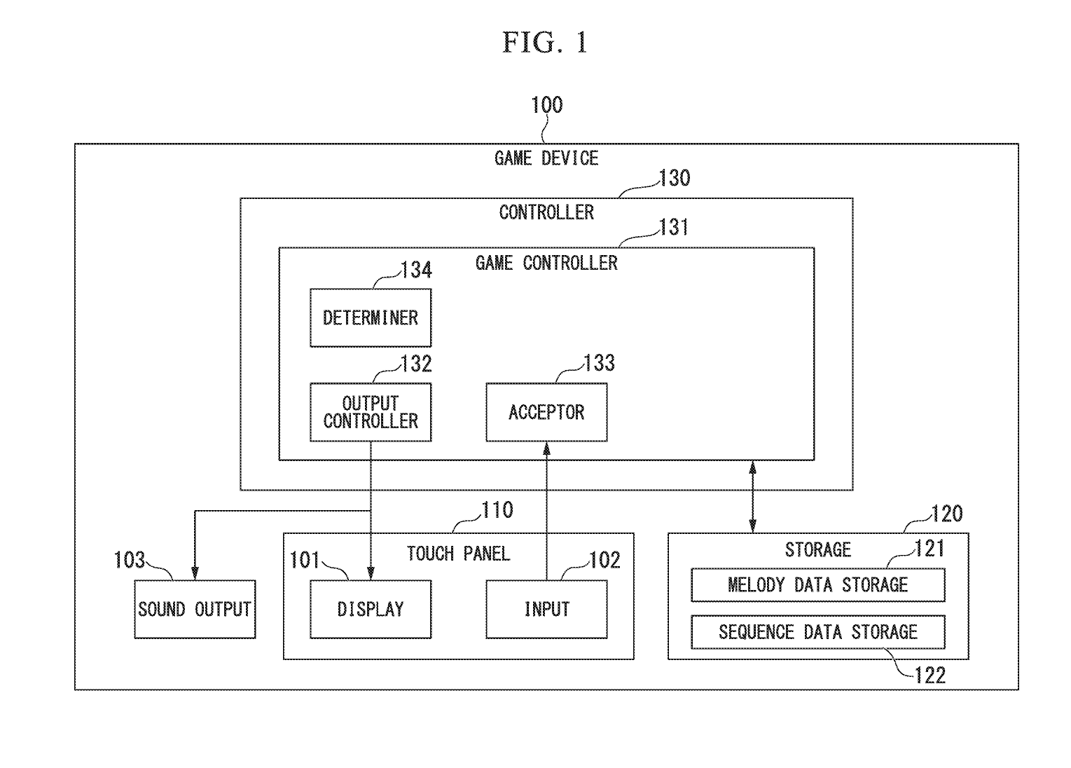

FIG. 1 is a block diagram showing the constitution of a game device 100 according to the present embodiment. The game device 100 is a terminal on which a user plays a game, this being, for example, a computer such as a commercial game machine installed in an amusement center or the like, a mobile telephone handset such as a smartphone, a PC (personal computer), a tablet PC, or game equipment. The game device 100 has a display 101, an input 102, a sound output 103, a storage 120, and a controller 130.

The display 101 is a display device having a screen that displays information such as images and characters.

The input 102 is an input device that generates an input signal in response to an operation made by a user.

For example, the input 102 is a keyboard or buttons, a pointing device such as a mouse, a touch panel, or the like. In the present embodiment, the example described is one in which a touch panel 110 on which the user makes operations integrates the display 101 and the input 102 as one. The operating method of the touch panel 110 may be any one of a resistive film type, a surface acoustic wave type, infrared type, electromagnetic induction type, and capacitive type, or the like.

The sound output 103 is a speaker that outputs sound.

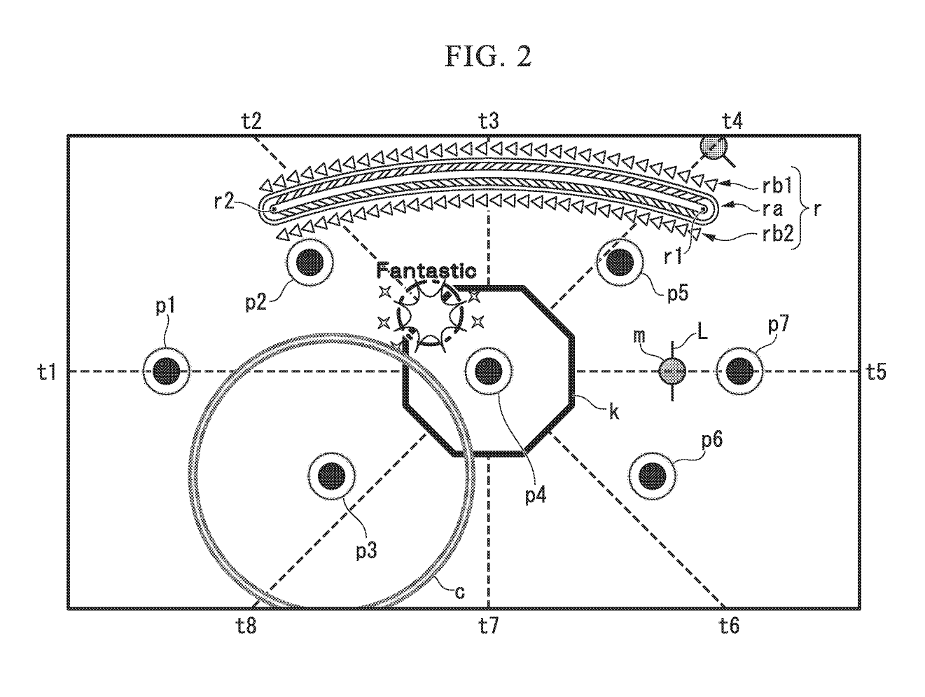

The game provided by the game device 100 of the present embodiment will now be generally described. FIG. 2 shows an example of the game screen that is displayed on the touch panel 110. The game provided by the game device 100 in the present embodiment is a timing game in which a success/failure determination is made in accordance with a prescribed operation that is input from a user at a timing in accordance with the progress of a melody. In this timing game, the success/failure determination is made based on a first reference indicator, a second reference indicator, and a path indicator.

The game device 100 displays a first reference indicator k at a prescribed position on the screen and displays a moving object m that moves toward the first reference indicator k. The game device 100 makes a first success/failure determination based on an operation timing of accepting input of a touch operation on the touch panel by the user and an arrival timing of the object m moving toward the first reference indicator k arriving at the first reference indicator k. If the determination of success is made in the success/failure determination, the user is granted a reward. Although the description will be for an example of the case of the reward being points or the like, the reward may be some item or the like in the game.

In the example in this drawing, an octagonal first reference indicator k is displayed at the center of a landscape-format rectangular screen, and moving objects m moving from outside the screen toward the first reference indicator k are displayed on paths perpendicular to each side of the first reference indicator k and extending toward the outside of the screen (path t1, path t2, path t3, path t4, path t5, path t6, path t7, and path t8). For example, if a user makes a touch operation at the time such a moving object m reaches the first reference indicator k, the moving object m is displayed so as to shine at the first reference indicator k. The example shown in the drawing is one in which a touch operation is made in response to the arrival timing of the moving object m on the path t2 reaching the first reference indicator k, and in which, as a result of the determination, the characters “Fantastic” are displayed. Although in FIG. 2 the paths are shown as dotted lines as an aid to understanding, there is no restriction to these dotted lines, and the paths need not be displayed on the screen. In the example of the this drawing, a line segment L parallel to the side of the first reference indicator k to which the moving object m is moving passes through the center of the moving object m. When a moving object m approaches the first reference indicator k, such a line segment L facilitates the visual grasping by the user of the relative timing relationship with the timing of other moving objects m toward the adjacent side. However, the line segment L need not be displayed.

The game device 100 displays a second reference indicator p at a prescribed position on the screen, displays a surrounding object c that surrounds the second reference indicator p, and shrinks the surrounding object toward the second reference indicator p. The game device 100 then makes a second success/failure determination, based on an operation timing of accepting input of a touch operation from the user and on the arrival timing of the surrounding object c shrinking toward the second reference indicator p arriving at the second reference indicator p.

The example of this drawing is one in which a second reference indicator p4 is displayed at the center of a landscape format rectangular screen and, at six surrounding locations, the second reference indicator p1, the second reference indicator p2, the second reference indicator p3, the second reference indicator p5, the second reference indicator p6, and the second reference indicator p7 are displayed.

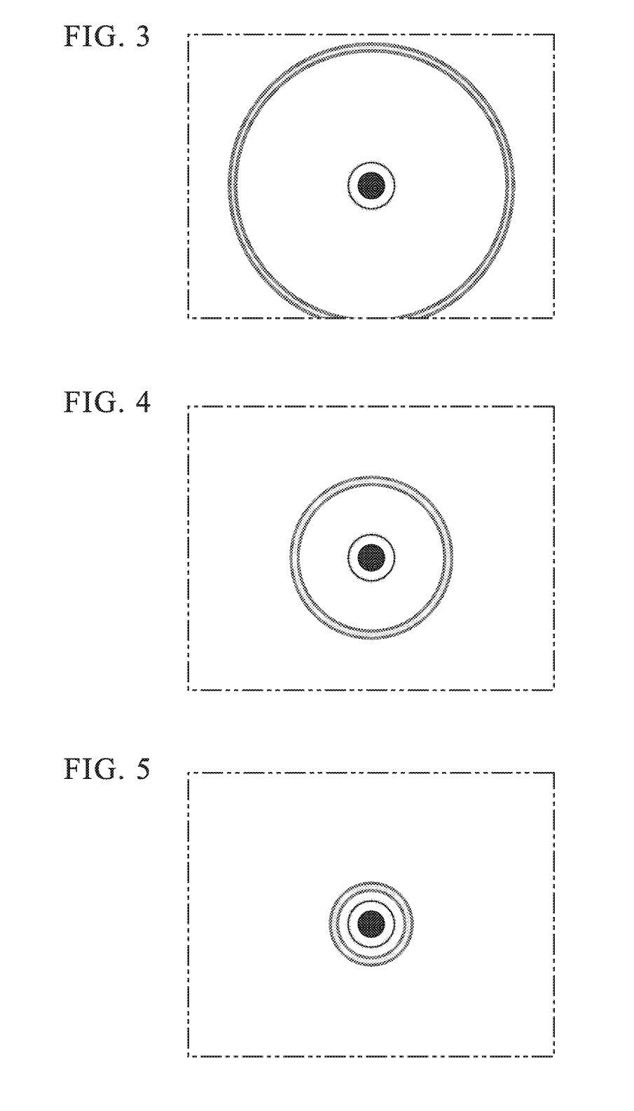

The game device 100 displays a surrounding object c that surrounds a second reference indicator p (for example, the second reference indicator p3) from a prescribed amount of time before the arrival timing, causes the surrounding object c to shrink toward the second reference indicator p3, and deletes the surrounding object c when it arrives at the second reference indicator p3. FIG. 3, FIG. 4, and FIG. 5 show the manner in which the surrounding object c shrinks toward the second reference indicator p. The example shown is that of a circular surrounding object c. The surrounding object c may be gradually accelerated as it shrinks toward the second reference indicator p3, or may shrink at a constant speed.

Returning to FIG. 2, the game device 100 displays a path indicator r at a prescribed position on the screen at a prescribed timing. The path indicator r indicates a prescribed path on which a tracing operation should be made during the prescribed operating time period from a prescribed starting time until a prescribed ending time. In some cases, the path indicator r shows a path to be traces in an arc from the starting point t1 to the ending point r2 from right to left. That is, this indicates a sliding operation in which a touch operation is made at the starting point r1 and the path indicator r is traced up to the ending point r2, while maintaining the touched condition.

The path indicator r may be non-displayed at first, then displayed up until the starting time during the melody when the user should make an operation, and then erased when the ending timing is passed. In this example, the path indicator r includes a bar indicator ra that indicates the path itself and triangular auxiliary indicates rb (rb1 and rb2) that are displayed along the bar indicator ra. The orientation of the vertices of the triangular auxiliary indicators rb indicates the direction in which the sliding operation should be made by the direction of the vertices. The game device 100 makes a path success/failure determination based on whether or not the user made an operation to trace the path indicator r during the prescribed operation time period in which the path indicator r is displayed. If the result of the path success/failure determination is a success, the user is granted a reward.

If the game device 100, as described above, makes a success/failure determination based on the arrival timing of the moving object moving toward the reference indicator arriving at the reference indicator and the operation timing of the user making a touch operation, the user can be guided regarding the distance between the object moving on the screen and the indicator and the operation timing, depending on the speed of movement of the object.

In contrast, if the success/failure determination is made in accordance with whether or not a sliding operation is made to trace the path indicator during a prescribed operation time period, if just the path indicator is displayed up until the starting time of the operation to be made, the user does not know at what speed the operation of the path indicator should be made and cannot adjust the operation timing. Given this, the game device 100 of the present embodiment displays the path indicator r gradually with the speed in accordance with the length of the prescribed operation time period. This enables the game device 100 to guide the user regarding the speed with which the path indicator r should be traced.

The construction of the game device 100 that provides such a game will be described in detail below.

Returning to FIG. 1, the storage 120 is constituted by a storage medium such as a RAM (random-access memory), ROM (read-only memory), or an HDD (hard disk drive) or the combination thereof, and stores various programs and information for the purpose of controlling various parts of the game device 100. The storage 120 has a melody data storage 121 and a sequence data storage 122.

The melody data storage 121 stores melody data that will be the game target.

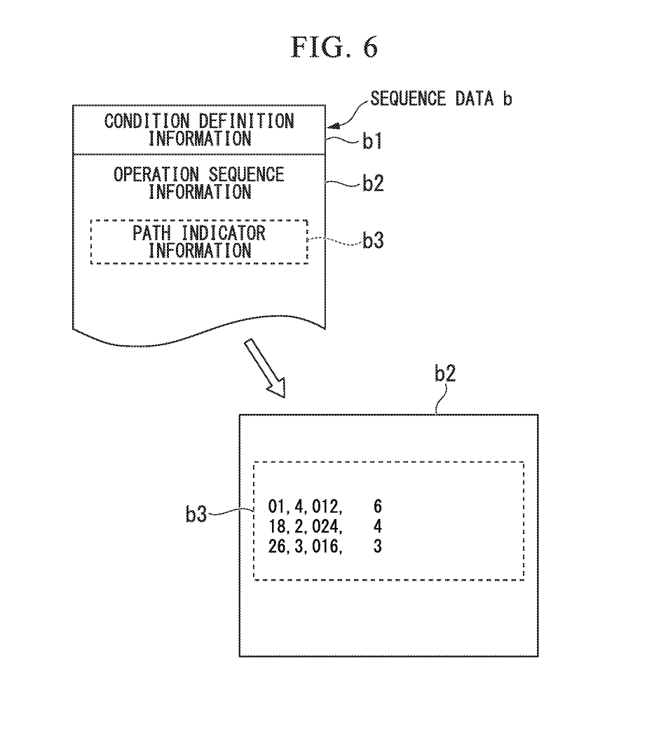

The sequence data storage 122 stores sequence data in which are coded the indicators and objects that are displayed in accordance with progression of the melody. At this point, the details of the sequence data will be described, with reference made to the drawing. FIG. 6 shows an example of the contents of the sequence data b. As shown in the drawing, the sequence data b includes the condition definition information b1 and the operation sequence information b2. In the condition definition information b1 is coded information indicating various conditions for executing a game, such as the melody ID for identifying the melody, the music tempo, the beat, the track, and the melody length.

In the operation sequence information b2 are coded the indicators and objects displayed in accordance with the progression of the melody, in association with times in the melody. Although the operation sequence information b2 includes moving object information regarding the first reference indicator and the moving objects corresponding thereto and surrounding object information regarding the second reference indicator and surrounding objects corresponding thereto, at this point the path indicator information b3 regarding the path indicator will be described. The operation sequence information b2 includes the path indicator information b3.

The path indicator information b3 indicates, for each path indicator to be caused to appear during a melody, the operation timing for operations to be made to trace that path indicator. In this example, the path indicator information b3 includes the starting time, at which the tracing operation with respect to that path indicator should be made, and the prescribed operation time period from the starting time to the ending time, in which the tracing operation should be made. The path indicator information b3 is constituted by a set of a plurality of records, in which this information is mutually associated.

In the example of the drawing, each information is coded, from the left, as the starting time and the prescribed operation time period, in that sequence.

The starting times are coded as values indicating the bar number within the melody, the beat number, and the time within a beat, separated by commas. The time within a beat is the elapsed time from the start of a beat, expressed as the number of units of time from the start thereof, when the length of a beat is divided evenly into n units of time. For example, if n=96, the time when ⅛ has elapsed from the start of the beat and the fourth beat of the first bar of a melody is specified as the starting time, would be coded as “01, 4, 012”.

A prescribed operation time period is information indicating the amount of time from the starting time until the ending time. The prescribed operation time period can be coded, for example, as a number of beats, and if the prescribed operation time period is coded as “6”, this indicates that the prescribed operation time period is the six beats from the starting time, the ending time being the point in time at which six beats have passed from the starting time.

The controller 130 has an information processing device such as a CPU (central processing unit) that functions as the control center of the game device 100 and controls the various parts of the game device 100. The controller 130 has a game controller 131. The game controller 131 is constituted so as to read out a game program stored beforehand in the storage 120. The game controller 131 has an output controller 132, an acceptor 133, and a determiner 134.

The output controller 132 controls the sound output of the sound output 103 and the image output of the touch panel 110. For example, when a user selects a melody for playing a game, the output controller 132 reads out and outputs to the sound output 103 the selected melody data from the melody data storage 121 so as to reproduce the sound. The output controller 132 displays the above-described game screen on the screen of the touch panel 110.

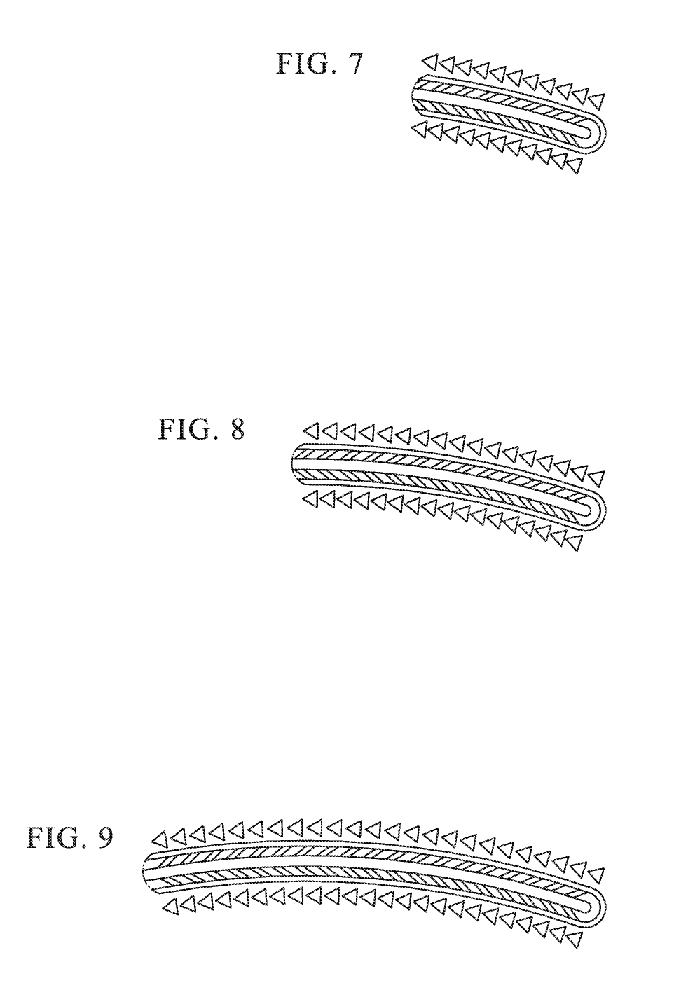

The output controller 132 gradually displays on the screen a path indicator r that indicates a prescribed path to be traced by a tracing operation during the prescribed operation time period from the prescribed starting time until the ending time, in accordance with the length of the prescribed operation time period. In some cases, the output controller 132 starts processing to gradually display the path indicator r from the appearance time before the starting time. For example, the output controller 132 can display the path indicator r gradually on the screen, so as to extend from the starting point r1 toward the ending point r2 of the path indicator r, with a speed in accordance with the length of the prescribed operation time period. An example of the gradual display of the path indicator r by the output controller 132 will be described below, with references made to FIG. 7, FIG. 8, and FIG. 9.

FIG. 7 shows a first example of the path indicator r that is gradually displayed by the output controller 132.

The example shown is that of the path indicator r from the right toward the left, which is displayed from the vicinity of the starting point r1 and has moved over approximately one-fourth of the overall path. FIG. 8 shows a second example of the path indicator r that is gradually displayed by the output controller 132. The path indicator r has been displayed from the right toward the left over approximately one-half of the overall path. FIG. 9 shows a third example of the path indicator r that is gradually displayed by the output controller 132. The path indicator r has been displayed from the right toward the left over approximately three-fourths of the overall path. By going through stages such as this, the output controller 132 displays the entire path indicator r, as shown in FIG. 2. This enables the output controller 132 to provide a guide to a user regarding the direction in which the path indicator r is to be traced, by displaying the path indicator r from the starting point r1 toward the ending point r2.

The output controller 132 can display the path indicator r gradually on the screen at a speed so that the elapsed time period to display the path indicator r from the starting point r1 until the ending point r2 is the same as the prescribed operation time period. Specifically, for example, the output controller 132 reads out the sequence data stored in the sequence data storage 122 in associations with the played back melody. The output controller 132 reads out the path indicator information in which the starting time that is included within a prescribed time range going forward from the current time is coded and, at an appearance time that is the read-out starting time minus the prescribed operating time period, displays the path indicator r from the starting point r1 on the screen up until the ending point r2, which is when the prescribed operation time period has elapsed from the appearance time. By doing this, by the elapsed time from the start of the display of the path indicator r until the completion of the overall display thereof, the user can be guided as the length of the prescribed operation time period. More specifically, for example, if the path indicator r corresponding to the path indicator information “18, 2, 024 4” stored in the path indicator information b3 is to be displayed, the output controller 132 first reads out the path indicator information from the sequence data storage 122. Next, the melody being played back is in 4/4 time, the appearance time of the path indicator r is determined to be “17, 2, 024”, which is the prescribed operation time period of “4” subtracted from the starting time of “18, 2, 024”. Then, when time of “17, 2, 024” determined to be the appearance time of the path indicator r arrives, the output controller 132 displays a part of the path indicator r at a prescribed position on the display 101. The path indicator r is gradually displayed over four beats that are the prescribed operation time period, up until the ending point. That is, for a played back melody in 4/4 time, the display of the path indicator r is completed at the time “18, 2, 024”.

The output controller 132 displays a first reference indicator k at a prescribed position on the screen and, based on the sequence data, displays a moving object m that moves toward the first reference indicator k. The output controller 132 displays a second reference indicator p at a prescribed position on the screen and, based on the sequence data, displays a surrounding object c that shrinks toward the second reference indicator p.

Although the above-described speed at which the elapsed time from the starting point r1 to the ending point r2 of the path indicator r, which is the same as the prescribed operation time period, may be a constant or substantially constant speed, this is not a restriction.

For example, the output controller 132 may display the path indicator r on the screen with a speed that gradually increases as it moves from the starting point r1 to the ending point r2, so that the elapsed time for the path indicator r to be displayed from the starting point r1 up until the ending point r2 is the same as the prescribed operating time period. Although the gradual increase of speed may be done with a fixed rate of increase, this is not a restriction, as long as the increase is monotonic.

The output controller 132 may display the path indicator r on the screen with a speed that gradually increases as it moves from the starting point r1 to the vicinity of a midpoint and with a speed that is constant or substantially constant from the vicinity of the midpoint up to the ending point r2, so that the elapsed time for the path indicator r to be displayed from the starting point r1 up until the ending point r2 is the same as the prescribed operating time period. The midpoint may be any point on the path between the starting point r1 and the ending point r2 and does not need to be an intermediate point that divides the path between the starting point r1 and the ending point r2 in half.

The output controller 132 may display the path indicator r on the screen with a speed that gradually increases as it moves from the starting point r1 to the vicinity of a midpoint and with a speed that gradually decreases as it moves from the vicinity of the midpoint to the ending point r2, so that the elapsed time for the path indicator r to be displayed from the starting point r1 up until the ending point r2 is the same as the prescribed operating time period. The speed is at a peak at the vicinity of the midpoint. Although the gradual increase of the speed is done with a fixed rate of increase, this is not a restriction, as long as the increase is monotonic. Although the gradual decrease of the speed may be done with a fixed rate of decrease, this is not a restriction, as long as the decrease is monotonic. The midpoint may be any point on the path between the starting point r1 and the ending point r2 and does not need to be an intermediate point that divides the path between the starting point r1 and the ending point r2 in half.

The output controller 132 may display the path indicator r on the screen with a speed that gradually decreases as it moves from the starting point r1 up until the ending point r2, so that the elapsed time for the path indicator r to be displayed from the starting point r1 up until the ending point r2 is the same as the prescribed operating time period. Although the gradual decrease of the speed may be done with a fixed rate of increase, this is not a restriction, as long as the decrease is monotonic.

The output controller 132 may display the path indicator r on the screen with a speed that gradually decreases as it moves from the starting point r1 up until the vicinity of the midpoint, and then moves with a constant or substantially constant speed from the vicinity of the midpoint up until the ending point r2, so that the elapsed time for the path indicator r to be displayed from the starting point r1 up until the ending point r2 is the same as the prescribed operating time period. In some cases, the midpoint may be any point on the path between the starting point r1 and the ending point r2 and does not need to be an intermediate point that divides the path between the starting point r1 and the ending point r2 in half.

The output controller 132 may display the path indicator r on the screen with a speed that gradually decreases as it moves from the starting point r1 up until the vicinity of the midpoint, and then moves with a speed that gradually increases from the vicinity of the midpoint up until the ending point r2, so that the elapsed time for the path indicator r to be displayed from the starting point r1 up until the ending point r2 is the same as the prescribed operating time period. In some cases, the speed in the vicinity of the midpoint is the minimum. Although the gradual increase of the speed may be done with a fixed rate of increase, this is not a restriction, as long as the decrease is monotonic. Although the gradual decrease of the speed may be done with a fixed rate of decrease, this is not a restriction, as long as the increase is monotonic. The midpoint may be any point on the path between the starting point r1 and the ending point r2 and does not need to be an intermediate point that divides the path between the starting point r1 and the ending point r2 in half.

Although a number of examples of the change of speed of the display of the path indicator r on the screen have been shown, there is no restriction to the above-described examples, it is sufficient that the elapsed time for the path indicator r to be displayed from the starting point r1 up until the ending point r2 is the same as the prescribed operation time period.

The monotonic increase and monotonic decrease includes the cases in which the proportion of increase or decrease over a short period of time is zero.

It is sufficient that the positions of the starting point r1 and the ending point r2 can be on the screen, and they are not restricted to having any specific positional relationship. The positions of the starting point r1 and the ending point r2 on the screen may be different or the same. Although many line segments can be given as examples of the case in which the positions of the starting point r1 and the ending point r2 on the screen being different, these are not restrictions. Although the various line segments include straight lines, zig-zag lines, and curved lines, these are not restrictions. The line segments may intersect midway and, for example, one might be in the shape of the letter α, although this is not a restriction. Also, although one of the starting point r1 and the ending point r2 may be midway in the line segment, this is not a restriction. For example, although the shape may be that of the number 6, this is not a restriction. As an example of the case in which the positions of the starting point r1 and the ending point r2 on the screen are the same, various closed lines can be given as examples, but these are not restrictions. Examples of various closed lines that can be cited are a looped curved line, a polygonal shape, the shape of ∞, and a circular shape, but these are not restrictions.

The acceptor 133 accepts input of operations from a user made with respect to the input 102. For example, the acceptor 133 accepts input of a touch operation with respect to an arbitrary position within the screen or a sliding operation that traces from a touch operation. Specifically, the acceptor 133, for example, accepts a sliding operation from the user with respect to the path indicator r.

The determiner 134 makes a success/failure determination of an operation accepted by the acceptor 133. For example, the determiner 134 makes a path success/failure determination based on the operation time of a sliding operation with respect to the path indication r accepted as input by the acceptor 133 to trace the path indicator r displayed by the output controller 132. For example, the determiner 134 determines a success if a sliding operation by the user to trace from the starting point r1 up to the ending point r2 of the path indicator r has been made within a prescribed operation time period from the starting time to the ending time as established by the path indicator information and determines a failure if it was not made.

In some cases, the path success/failure determination processing includes position determination processing based on the operation position at which a sliding operation has been made and timing determination processing based on the operation timing of a sliding operation that has been made. The determiner 134 performs position determination processing in accordance with the positional relationship between the operation position at which the sliding operation has been made and the position of the path indicator r. Specifically, the determiner 134 makes a determination of a success if the path indicator r exists, and a failure if the path indicator r does not exist, within a prescribed range from the operation position at which the sliding operation has been made.

The determiner 134 performs timing determination processing that determines a success if the operation timing at which a sliding operation that has been determined to be a success by the position determination processing is within a prescribed amount of operation time from the starting time to the ending time, as established by the path indicator information, and determines a failure if it is not. If the determiner 134 determines a success in both the position determination processing and the timing determination processing in this manner, the path success/failure determination is determined to have succeeded, and if at least one of the position determination processing and the timing determination processing fails, the path success/failure determination is determined to have failed.

The determiner 134 performs a first success/failure determination, based on the arrival time of the moving object m that moves toward the first reference indicator k at the first reference indicator k, and the operation time of acceptance by the acceptor 133 of an input of a touch operation. The determiner 134 also performs a second success/failure determination, based on the arrival time of the surrounding object c that shrinks toward the second reference indicator p, and the operation time of acceptance by the acceptor 133 of an input of a touch operation.

Next, an example of the operation of the game device 100 according to the present embodiment will be described.

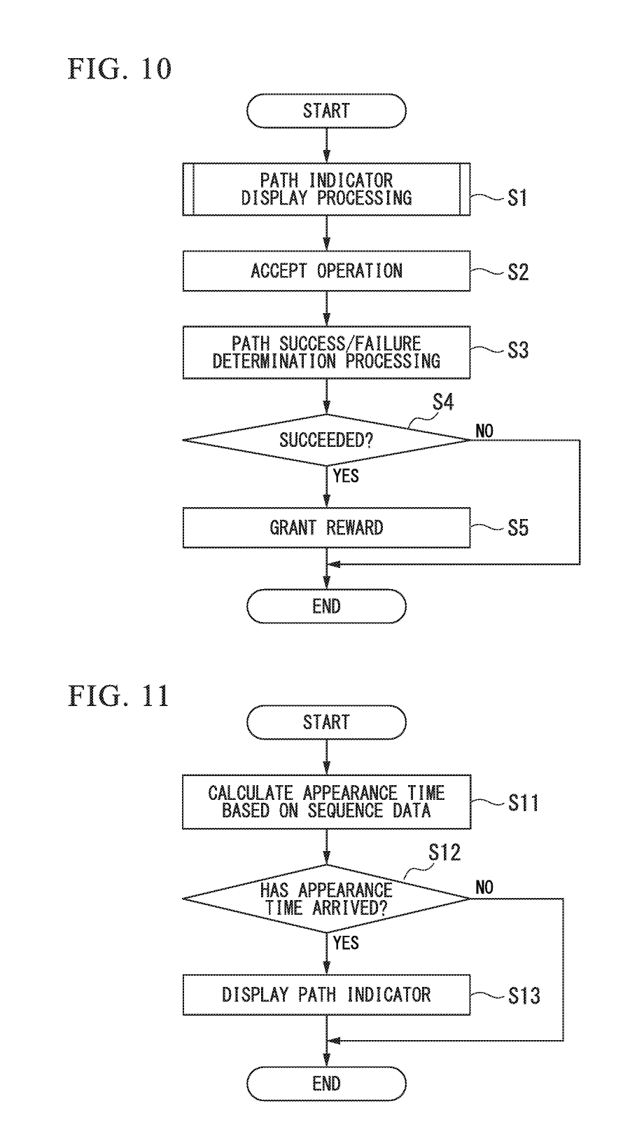

FIG. 10 is a flowchart showing an example of the operation of the game device 100 according to the present embodiment.

When the starting of a game provided by the game device 100 is selected by the user and the melody to be played is selected, the output controller 132 displays a game screen that includes a first reference indicator k and a second reference indicator p, reads out the selected melody data from the melody data storage 121, causes the sound output 103 to output and to reproduce the melody, reads out the sequence data corresponding to the melody from the sequence data storage 122, and starts the game.

During the game time period from the start of reproduction of the melody to the end thereof, the game controller 131 continuously repeats execution of the processing from step S1 to step S5.

The output controller 132 performs the path indicator display processing, based on the sequence data, in accordance with the progress of the melody (step S1). FIG. 11 is a flowchart showing an example of the operation in the path indicator display processing by the game device 100.

The output controller 132 does timekeeping of the elapsed time from the start of playback, using the point in time of the start of the melody playback as a reference, and calculates the appearance time of a moving object, based on the sequence data read out from the sequence data storage 122 (step S11). For example, the output controller 132 calculates the appearance time by subtracting a prescribed amount of operation time from the starting time included in the path indicator information included in the sequence data.

The output controller 132 compares the calculated appearance time with the elapsed time from the start of playback of the melody and, if the determination is that the appearance time has not yet arrived (NO at step S12), the processing is ended. If the determination is made that the appearance time has arrived (YES at step S12), a path indicator r is gradually displayed in accordance with the length of the prescribed operation time established in the path indicator information corresponding to that appearance time (step S13).

Returning to FIG. 10, the acceptor 133 accepts input of a sliding operation from the user in accordance with the progression of the melody (step S2). The determiner 134 performs path success/failure determination processing, based on the input sliding operation (step S3). If the determiner 134 determines a success in the path success/failure determination processing (YES at step S4), the game controller 131 grants a reward to the user (step S5). If the determiner 134 determines a failure in the path success/failure determination processing (NO at step S4), no reward is granted. When the ending time, which is the time at which the prescribed operation time period has elapsed from the starting time at which the path indicator r had been displayed, has passed, the path indicator r that had been displayed at step S1 is erased by the output controller 132.

As described above, according to the present embodiment, in a timing game in which a path success/failure determination is made with respect to a sliding operation made on a path indicator r displayed in accordance with the progression of a melody, because the path indicator r display is started at an appearance time in accordance with the length of the prescribed operation time period with respect to the path indicator r and the display is made gradually up until the starting time, it is possible to provide a guide to the user regarding the prescribed operation time period by the speed of the gradual display of the path indicator r. Even if the user is not accustomed to the timing game or is playing a melody for the first time, the form of the display manner of the path indication r that is gradually displayed enables an intuitive grasp of the timing and speed with which the sliding operation should be made with respect to the path indicator r, thereby enabling the user to enjoy the game.

Also, according to the present embodiment, in addition to touch operations with respect to a first reference indicator k and a moving object m and touch operations with respect to a second reference indicator p and a surrounding object c, it is possible to enjoy sliding operations with respect to a path indicator r, thereby enabling the provision of new game enjoyment. It is possible to provide a new presentation, in which a path indicator r is displayed in accordance with the length of the prescribed operation time period for making a sliding operation with respect to that path indicator r, and it is possible to provide new game enjoyment.

Although the above-described example in one in which the output controller 132 calculates the appearance time of the path indicator r as the starting time established by the path indicator information minus the prescribed operation time period, this is not a restriction, and it is sufficient that the appearance time is different, depending upon the length of the prescribed operation time period. That is, it is sufficient that control be performed so that the user can grasp the relative length of the prescribed operation time period by the speed of the gradual display of the path indicator r. For example, the appearance time may be made a time that is the starting time minus the product of the prescribed operation time period multiplied by a prescribed coefficient. For example, the calculation may be done so that, if the prescribed operation time period is one beat, the time that is the starting time minus 0.5 beat may be taken as the appearance time, and if the prescribed operation time period is five beats, the time that is the starting time minus 2.5 beats may be taken as the appearance time. In some cases, the rendering processing from the starting point to the ending point of the path indicator r can be completed before the starting time, and the rendering processing for the leading part of the path indicator r may continue even at the starting time. That is, in the latter case, the starting time arrives in the condition in which the rendering processing of the leading part of the path indicator r is continuing, and the user makes a sliding operation so as to chase after the rendering processing.

It is sufficient that the elapsed time (required rendering processing time) for the output controller 132 to display the path indicator r from the starting point r1 up to the ending point r2, that is, the rendering speed with which the path indicator r enables the user to grasp the relative length of the prescribed operation time period. For example, the output controller 132 can perform rendering processing of the gradual display of the path indicator r, in a required rendering time that is the prescribed operation time period multiplied by a prescribed coefficient. For example, if the prescribed operation time period is six beats and the coefficient is 0.5, the output controller 132 performs rendering processing to display the path indicator r gradually in the required rendering time of three beats.

It is sufficient that the appearance time be at least before the starting time. For example, with the appearance time always six beats before the starting time, the path indicator r may be displayed gradually from the appearance time, with a speed in accordance with the length of the prescribed operation time period. In some cases, for example, if the prescribed operation time period is four beats, the path indicator r is displayed over four beats from six beats before the starting time, with two beats from the display of the path indicator r at the ending point free before the start time. Also, in some cases, for example, if the prescribed operation time period is eight beats, the path indicator r is displayed over eight beats from six beats before the starting time, and the starting time arrives at the point at which six beats have elapsed after the start of the path indicator r display, after which, when two beats have elapsed, the path indicator r is displayed up until the ending point. In some cases, the user makes a sliding operation so as to chase after the rendering processing.

Also, for example, the appearance time may be taken to be the sum of the prescribed operation time period and a prescribed time period (prescribed number of beats) subtracted from the starting time. For example, with the prescribed time period established beforehand as one beat, if the time that is always the sum of the prescribed operation time period and one beat subtracted from the starting time is taken to be the appearance time, one beat after the path indicator r is displayed up to the ending point is the starting time. By doing this, the time from the completion of the display of the path indicator r until the starting time is always the same, making it easier for the user to adjust the timing.

Although in the above description the example shown has been that of gradually displaying the path indicator r to extend from the starting point r1 toward the ending point r2, as long as that form of display can guide the user regarding the prescribed operation time period, another form of display can be used. For example, it is possible to divide the length of the prescribed operation time period into a plurality of steps and cause display of the path indicator in different colors or shapes, depending upon the length step. The user can also be guided as to the prescribed operation time period, for example, by the case in which, if the path indicator is displayed red, the prescribed operation time period is short, if it is displayed yellow, the prescribed operation time period is long, relative to the case in which it is red, and if it is displayed blue, the prescribed operation time period is long, relative to the case in which it is yellow. For example, contrast control may be done so that the entire path indicator r may be displayed faintly at the appearance time and made gradually more distinct with the elapse of time, so that it has a prescribed contrast at the starting time. In the case in which an object to be displayed on the screen is generated by a three-dimensional model (polygons), the form of displaying such a path indicator r may be controlled by changing the colors in the vertex buffer of the object. This enables a lightening of the processing load, compared with real-time generation of polygons.

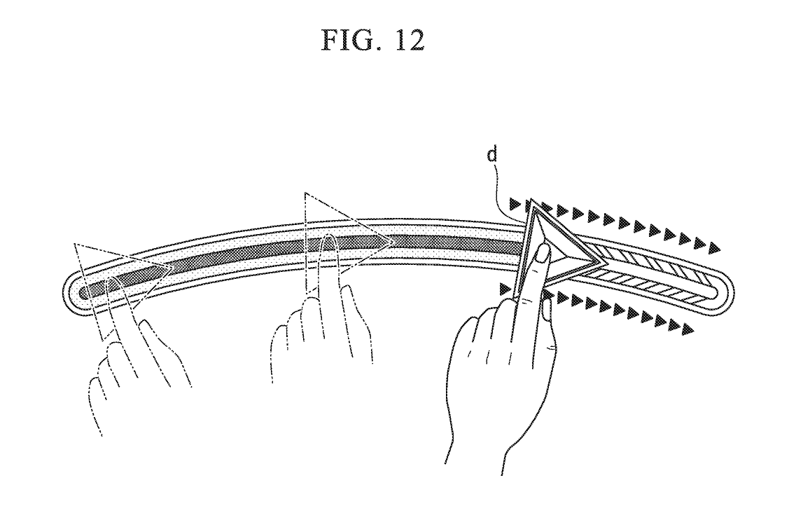

Although the above example has been one in which the path indicator r is to be subjected to a sliding operation from the right to the left, a path indicator r may be displayed to be subjected to a sliding operation from the left to the right. Also, an operation object indicating that a user is performing a touch operation may be displayed at the touch position over the path indicator r that is being subjected to sliding by the user. FIG. 12 shows an example of a path indicator r displaying this type of image. In some cases, a path indicator r that is to be subjected to sliding operation from the left to the right is displayed. A triangular operation object d is displayed at the position touched by the user. The operation object d moves over the path indicator r in concert with the operation position, in response to the movement of the operation position over the path indicator r being touched by the user. This enables the user to intuitively grasp what position the user is touching on the path indicator r.

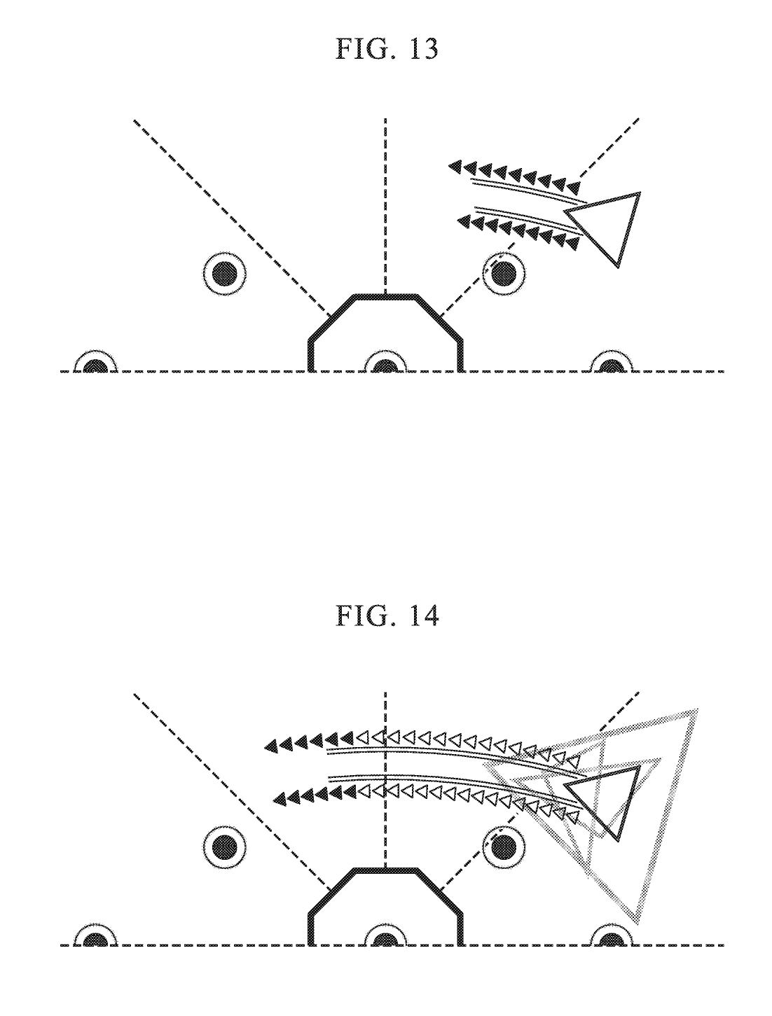

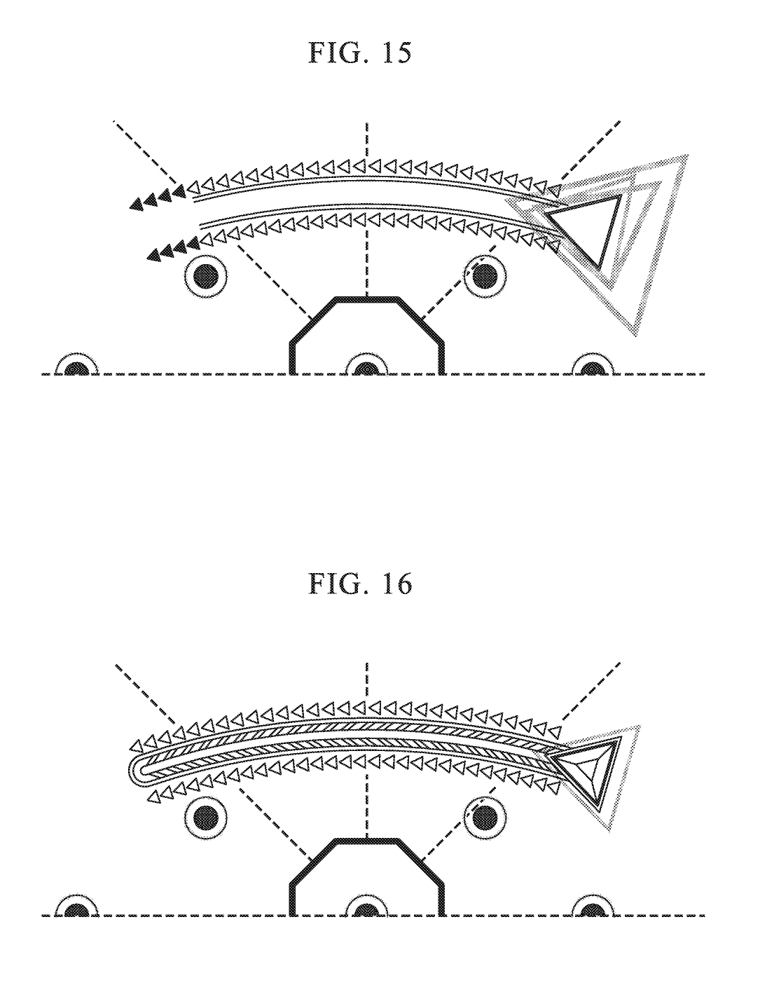

Although the above example shows the synchronous gradual display of the bar indicator ra and the auxiliary indicator rb included in the path indicator r, either one of these alone may be displayed and, for example, the display of the auxiliary indicator rb alone may be started at the appearance time, with the bar indicator ra presented at the point in time when the auxiliary indicator rb reaches up to the ending point. The above-described operation object d may be displayed in accordance with the starting time at which the sliding operation should be made with respect to the path indicator r. FIG. 13, FIG. 14, FIG. 15, and FIG. 16 show examples of the path indicator r that displays such an image.

FIG. 13 shows an example of the display at a first point in time, at which only the auxiliary indicator rb in the path indicator r is displayed at first. When the appearance time arrives, the output controller 132 displays only the auxiliary indicator rb in the path indicator r, from the starting point r1. At this point in time, only the triangular contour of the operation object d is displayed.

FIG. 14 shows an example of the display at a second point in time, at which only the auxiliary indicator rb in the path indicator r are displayed at first. Regarding the path indicator r, at this point in time, only approximately fourth fifths of the overall auxiliary indicator rb is displayed, from the starting point r1 toward the ending point r2. A plurality of triangles are displayed around the operation object d so as to shrink toward the operation object d.

FIG. 15 shows an example of the display at a third point in time, at which only the auxiliary indicator rb in the path indicator r is displayed at first. Regarding the path indicator r, at this point in time, only the auxiliary indicator rb is displayed to approximately the ending point r2. A plurality of triangles are displayed around the operation object d so as to shrink toward and approach the operation object d.

FIG. 16 shows an example of the display at the fourth point in time, at which only the auxiliary indicator rb in the path indicator r is displayed first. Regarding the path indicator r, only the auxiliary indicator rb is displayed up until the ending point r2, after which the bar indicator ra is displayed. At the point in time at which the plurality of triangles are displayed around, are shrinking toward, and have sufficiently approached the operation object d, not only the contour of the operation object d, but also the internal image thereof may be displayed.

This enables the provision of a new presentation regarding the method of displaying the path indicator r. It is also possible to provide a new presentation regarding the display of the operation object d. Additionally, for example, the point in time at which the all of the plurality of triangles that shrink toward operation object d overlap with the operation object d and the internal image of the operation object d is also displayed can be made to coincide with the starting time at which the sliding operation with respect to the path indicator r should be made. This enables the display timing of the operation object d to guide the user regarding the starting time.

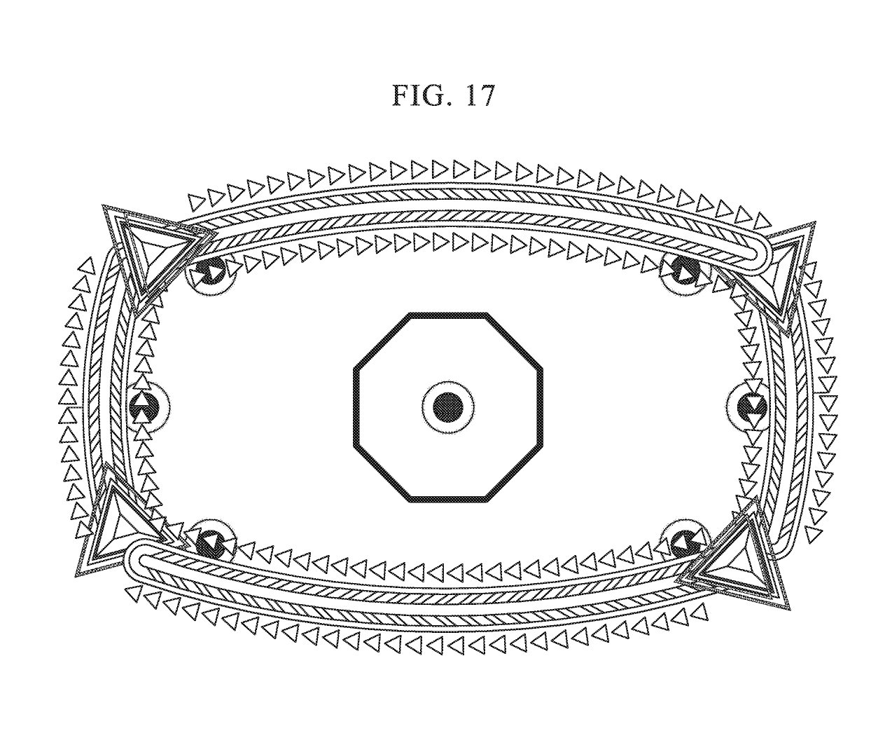

Although the above-described example is one in which one path indicator r is displayed in the upper part of the screen so as to arch left-to-right, a plurality of path indicators r may be displayed at a different position on the screen. FIG. 17 shows an example of a screen displaying a plurality of path indicators r. In some cases, a path indicator r is displayed so as to describe an upwardly convex arc at the top of the screen, a path indicator r is displayed so as to describe a downwardly convex arc at the bottom of the screen, a path indicator r is displayed so as to describe a leftwardly convex arc at the left side of the screen, and a path indicator r is displayed so as to describe a rightwardly convex arc at the right side of the screen. The output controller 132 can display one or all of these path indicators r at the plurality of positions, in accordance with the progression of a melody. In some cases, in addition to the starting times and prescribed operation time periods, the sequence data path information can be made to store, for example, position information indicating the position at the top, bottom, left, or right at which a path indicator r is to be displayed and direction information indicating the direction from the starting point r1 to the ending point r2 along the path as upward, downward, leftward, or rightward. Rather than a curved line, the shape of a path indicator r may be a straight line and may be, for example, piecewise linear, or circular.

Although in the above-described example the determiner 134 determines a failure or success in the path success/failure determination processing, a different evaluation in a plurality of steps can be made by one or both of the degree of difference between the operation position in the position determination processing and a prescribed evaluation position of the ending point r2 or the like of the path indicator r, and the degree of difference between the operation time in the timing determination processing and the prescribed operation time period. For example, control can be performed so that the determination of success in the position determination processing is divided into three steps, the case of the operation position being within a prescribed range with respect to the path indicator being “Fantastic”, and the evaluation being lowered to “Great” to then to “Good” with increasing distance of the operation position with respect to the path indicator. Specifically, evaluation can be done so that, for example, at the point in time at which the prescribed operation time period has elapsed, if the operation object d has reached the ending point r2 of the path indicator r, the evaluation “Fantastic” is made, if the operation object d has not reached the ending point r2 of the path indicator r but has reached from the starting point r1 to a position that is at least two-thirds the overall length of the path indicator r, the evaluation “Great” is made, and, if the operation object d has reached from the starting point r1 to a position that is at least one-third but less than two-thirds the overall length of the path indicator r, the evaluation “Good” is mad, with the evaluation “Missed” (failure) made for lower than that. In the same manner, in the timing determination measure, if the difference between the operation time and the prescribed operation time period is at least 0.0 s and within 0.2 s, the determination result can be made “Fantastic”, if the difference between the operation time and the prescribed operation time period is at least 0.21 s and within 0.4 s, the determination result can be made “Great”, and if the difference therebetween is at least 0.41 s and within 0.8 s, the determination result can be made “Good”, with a difference of 0.81 s or greater being taken to be “Missed” (failure). A multi-step evaluation may be made, based on the determination results of both the timing determination processing and the position determination measure. For example, the determination results of both the timing determination processing and the position determination measure can be taken as values, and an evaluation in a plurality of steps can be made in accordance with the sum or the product of those values. This type of evaluation determination processing may be performed after the prescribed operation time period has elapsed, or at every prescribed point in time before the prescribed operation time period has elapsed. For example, an additive method may be used in which the determination processing is performed each time one-third of the prescribed operation time period elapses, and a determination is made each time as to whether or not to add one-third of the total number of points to be achieved for the operation with respect to the path indicator r at that time.

During the game period from the start to the end of the playback of the melody, the game device 100 calculates a score based on the determination results of each of the first success/failure determination, the second success/failure determination, and the path success/failure determination, and can display the total score within the game. When doing this, for example, based on the individual determination results or score each time, a game may be cleared, a new stage, melody, or some item may be provided.

Although the above-described example has been one in which path indicator information of the sequence data includes information of the starting times and prescribed operation time periods, the path indicator information may indicate by other information the timing of operations with respect to the path indicator. For example, as path indicator information, the prescribed operation time periods and ending times may be associated and stored in sequence data storage 122, and the output controller 132 can calculate the starting times by subtracting the prescribed operation time periods from the ending times. As path indicator information, the starting times and the ending times may be associated and stored in the sequence data storage 122, and the output controller 132 can calculate the prescribed operation time periods as the differences between the starting times and the ending times. As path indicator information, the starting times, the ending times, and the prescribed operation time periods may be associated and stored in the sequence data storage 122.

Although the above-described example is one in which the number of beats is coded as the prescribed operation time period included in the path indicator information of the sequence data, the number of bars or time (for example, seconds) may be coded in the prescribed operation time periods.

Although the above-described example has been one in which a touch panel is used as the input 102, if the input 102 is a keyboard, prescribed operation inputs may be assigned to prescribed keys of the keyboard, and input may be accepted by sensing the operation of those keys. If a button is used as the input 102, one or a plurality of buttons may be provided in correspondence to operations required for the game, and an input may be accepted by sensing the pressing of a button. If a pointing device is used as the input 102, a cursor displayed on the display 101 may be appropriately moved, and an input may be accepted by performing a clicking operation or the like with the pointing device.

Although the above-described example has been one in which the first reference indicator k is octagonal, as long as the first reference indicator k is such that the moving object m reaches it, it can be any shape. For example, it may be polygonal, such as triangular or square, and may be circular, and moving objects may be made to move toward each of the sides or the circumference of such shapes.

Although the above-described example has been one in which the path of movement of a moving object m is a straight line, it may be a curved line or a piecewise-linear line or the like.

Although the above-described example has been one in which a surrounding object is circular, as long as the surrounding object c has a shape so as to surround the second reference indicator p and shrinks overall toward the second reference indicator p, it may be a different shape. For example, the surrounding object c may be polygonal, such as triangular or square. The surrounding object c may be lines (solid lines) such as shown in the above-noted example, or may be dotted lines. For example, a plurality of objects in a row so as to surround the second reference indicator p may simultaneously move toward the second reference indicator p, so that the overall surrounding object c shrinks toward the second reference indicator p.

Although the above-described example has been one in which a game controller 131 is constituted and a game program for executing a game is stored in the storage 120 beforehand, a game program transmitted via a network, for example, may be received and installed in the game device 100 and stored into the storage 120, or a game program stored into a removable storage medium may be read out, installed, and stored in the storage 120.

The game device 100 may be implemented as a computer used by the user, or may be implemented as a server device that communicates with a terminal operated by the user, in the form of a so-called cloud game, or may be implemented as a game system, which is the combination of a terminal operated by the user and a server device that communicates with the terminal. Implementation is also possible as a fixed-type game device such as a consumer game device or home game device, or as a game device that is a portable information terminal referred to as a portable game console, or as a game machine referred to as an arcade game machine or commercial game machine. Implementation as a game method by these types of game systems and game devices is possible, and implementation is possible as a game program to operate the computers of these game systems and game devices. The game program may be one that is embedded in a game system or game device beforehand or, for example, may be distributed together with an installer and installed later into a game system or game device.

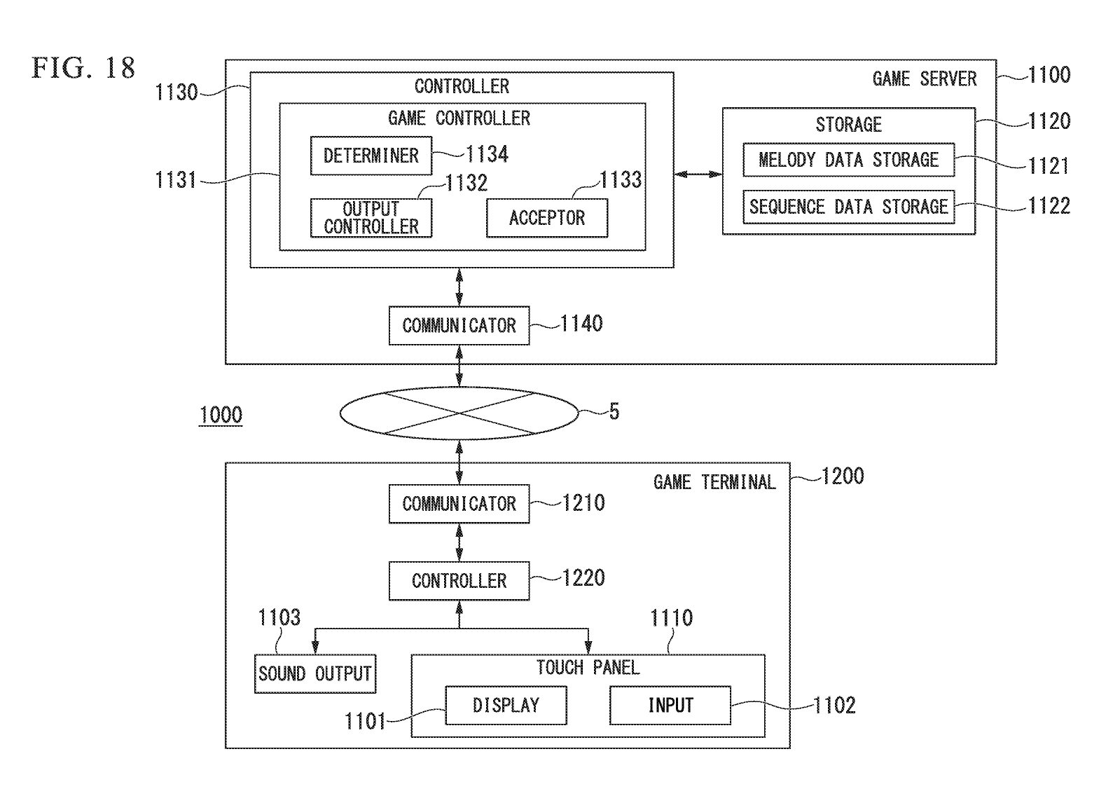

FIG. 18 is a block diagram showing an example of the constitution of a game system 1000 according to another embodiment of the present invention. In some cases, an example of the game system 1000 is shown as being the combination of a game terminal 1200 operated by a user and a game server 1100 that communicates with the game terminal 1200. The game system 1000 is a computer system providing a game referred to as a cloud game.

The gamer server 1100 and the game terminal 1200 are connected via a network 5. The network 5 includes, for example, the Internet, a WAN (wide area network), a LAN (local area network), a dedicated line, or an information communication network constituted by a combination thereof.

The game server 1100 has a storage 1120, a controller 1130, and a communicator 1140. The storage 1120 has a melody data storage 1121 and a sequence data storage 1122. The controller 1130 has a game controller 1131, and the game controller 1131 has an output controller 1132, an acceptor 1133, and a determiner 1134.

The storage 1120, the melody data storage 1121, and the sequence data storage 1122 are the same as the storage 120, the melody data storage 121, and the sequence data storage 122 in the above-described embodiment. The controller 1130, the game controller 1131, the output controller 1132, the acceptor 1133, and the determiner 1134 are the same as the controller 130, the game controller 131, the output controller 132, the acceptor 133, and the determiner 134 in the above-described embodiment.

The communicator 1140 communicates with the game terminal 1200 via the network 5. For example, the communicator 1140 transmits to, and displays on, the game terminal 1200 information of a screen generated by the output controller 1132. The communicator 1140 outputs and transmits to the game terminal 1200 melody data output from the output controller 1132. The communicator 1140 receives a signal indicating an operation by a user input to the game terminal 1200 and inputs it to the acceptor 1133.

The game terminal 1200 has a touch panel 1110 that has a display 1101 and an input 1102, and a sound output 1103, a communicator 1210, and a controller 1220.

The display 1101, the input 1102, the touch panel 1110, and the sound output 1103 are the same as the display 101, the input 102, the touch panel 110, and the sound output 103 in the first embodiment.

The communicator 1210 communicates with the game server 1100 via the network 5. For example, the communicator 1210 receives game screens and melody data transmitted from the game server 1100. The communicator 1210 transmits to the game server 1100 a signal indicating an operation by a user input to the input 1102.

The controller 1220 controls the various parts of the game terminal 1200. For example, the controller 1220, based on information received by the communicator 1210 from the game server 1100, displays game screens on the display 1101 and plays back a melody to the sound output 1103. The controller 1220 transmits to the game server 1100 via the communicator 1210 a signal indicating an operation by a user input to the input 1102.

Although an example in which the game server 1100 has a melody data storage 1121 is shown, when a game is played, the melody data selected by playing can be downloaded beforehand into the game terminal 1200 before the start of the game. In some cases, the display of reference indicators and objects is controlled by the real-time generation and transmission of the screen by the output controller 1132 of the game server 1100 after the start of the game, while the game terminal 1200 plays back melody data it had downloaded and stored in its own storage before the start of a game.

In this manner, the various functional units of the game device 100 and the game system 1000 can be distributed between or concentrated in an arbitrary number of computers, in accordance with the cloud environment or the network environment, the scale in terms of number of users, and the amount and specifications of hardware available for implementing the game system.

Although the above-described embodiments have been described for a touch panel 110 used as the input 102, if a touch pad is used as the input 102, implementation is possible by touching or the like of a position on the touch pad corresponding to the display 101.

If a keyboard or buttons are used as the input 102, operations with respect to a moving object or a surrounding object can be made by pressing a key on the keyboard or a button that has been assigned thereto. A constitution can be adopted in which an operation with respect to a path indicator is made by pressing a key of the keyboard or a button assigned in correspondence to the path indicator. Therefore, if an operation is made with respect to a path indicator, an evaluation can be made in accordance with the starting time of pressing or the duration of pressing a key or a button.

If a pointing device is used as the input 102, a mark corresponding to the pointing device is displayed on the display 101. The mark corresponding to the pointing device is then moved and a click operation is made to perform an operation with respect to a moving object or a surrounding object. A constitution can be adopted wherein, when an operation is to be made with respect to a path indicator, a click can be made with the mark aligned at the starting point r1 and the mark can be dragged as is to move it to the ending point r2.

As described above, one aspect of the embodiments may be a game program that causes a computer of a game device (for example, the game device 100 or the game server 1000) to execute an output control step of gradually displaying a path indicator indicating a prescribed path to be traced by an operation during a prescribed operation time period from the prescribed starting time to the ending time on a screen, with a speed in accordance with the length of the prescribed operation time period.

This enables the user to be guided regarding the timing of an operation to be made on a path indicator in a timing game, thereby enabling enjoying of the game by a broader range of users.

Because this also enables even a user not accustomed to timing games to grasp the proper timing to make an operation on a path indicator, it is possible to enhance the enjoyment of the game.

An aspect of the embodiments may be the game program wherein, in the output control step, processing to gradually display the path indicator is started from an appearance time that is before the starting time.

Another aspect of the embodiments may be a game control method that executes the step.

Another aspect of the embodiments may be a game device or game system having the game program.

This enables the user to be guided regarding the timing to make operation on a path indicator before the starting time at which the user should start operation.

An aspect of the embodiments may be the game program, wherein, in the output control step, the path indicator is displayed on the screen so as to gradually extend with a speed in accordance with the length of the prescribed operation time period, from the starting point of the path indicator to the ending point of the path indicator.

An aspect of the embodiments may be a game program that causes the computer of a game device (for example, the game device 100 or the game server 1100) to further execute an accepting step of accepting an operation with respect to the path indicator from a user and a determining step of making a success/failure determination of an operation with respect to the path indicator accepted by the accepting step.

This may also be a game control method of executing the above-noted steps.

This may also be a game device or a game system having the game program.

This enables the user to be guided regarding the operation direction of the path indicator.

An aspect of the embodiments may be the game program, wherein, in the output control step, the path indicator is gradually displayed on a screen with a speed so that the elapsed time from the starting point to the ending point of the path indicator is the same as the prescribed operation time period.

This may be a game control method that executes the step.

This may be a game device or game system that has the game program.

This enables the user not only to be guided with regard to the relative length of the prescribed operation time period to make an operation on the path indicator, but also to be guided with more precision with regard to the length of the prescribed operation time period.

An aspect of the embodiments may be a game device that includes: an output controller (for example, the output controller 132 or the output controller 1132) that gradually displays a path indicator indicating a prescribed path to be subject to a tracing operation during a prescribed operation time period from a prescribed starting time to an ending time on a screen with a speed in accordance with the length of the prescribed operation time period; an acceptor (for example, the acceptor 133 or the acceptor 1133) that accepts an operation with respect to the path indicator from a user; and a determiner (for example, the determiner 134 or the determiner 1134) that performs a success/failure determination of an operation on the path indicator accepted by the acceptor.

An aspect of the embodiments may be a game control method, whereby a game device (for example the game device 100 or the game device 1100) executes: an output control step of gradually displaying a path indicator indicating a prescribed path to be subject to a tracing operation during a prescribed operation time period from a prescribed starting time to an ending time on a screen with a speed in accordance with the length of the prescribed operation time period; an accepting step of accepting an operation with respect to the path indicator from a user; and a determining step of performing a success/failure determination of an operation with respect to the path indicator accepted by the accepting step.

An aspect of the embodiments may be a game program causing a computer of a game device (for example, the game device 100 or the game server 1100) to execute: an output control step of displaying a path indicator indicating a prescribed path to be subject to a tracing operation during a prescribed operation time period from a prescribed starting time to an ending time on a screen with a form of display in accordance with the length of the prescribed operation time period; an accepting step of accepting an operation with respect to the path indicator from a user; and a determining step of performing a success/failure determination of an operation with respect to the path indicator accepted by the accepting step.

An aspect of the embodiments may be a game program causing a computer of a game system (for example, the game device 100 or the game server 1100) to execute: an output control step of gradually displaying a path indicator indicating a prescribed path to be subject to a tracing operation during a prescribed operation time period from a prescribed starting time to an ending time on a screen with a speed in accordance with the length of the prescribed operation time period; an accepting step of accepting an operation with respect to the path indicator from a user; and a determining step of performing a success/failure determination of an operation with respect to the path indicator accepted by the accepting step.

An aspect of the embodiments may be a game system having: an output controller (for example, the output controller 132 or the output controller 1132) that gradually displays a path indicator indicating a prescribed path to be subject to a tracing operation during a prescribed operation time period from a prescribe starting time to an ending time on a screen, with a speed in accordance with the length of the prescribed operation time period; an acceptor (for example, the acceptor 133 or the acceptor 1133) that accepts an operation with respect to the path indicator from a user; and a determiner (for example, the determiner 134 or the determiner 1134) that performs success/failure determination of an operation with respect to the path indicator accepted by the acceptor.

An aspect of the embodiments may be a game control method whereby a game system (for example, the game device 100 or the game server 1100) has: an output control step of gradually displaying on a screen a path indicator indicating a prescribed path to be subject to a tracing operation during a prescribed operation time period from a prescribe starting time to an ending time; an accepting step of accepting an operation with respect to the path indicator from a user; and a determining step of performing a success/failure determination of an operation with respect to the path indicator accepted by the accepting step.

The systems and methods in the above-described embodiments may be deployed in part or in whole through a machine that executes computer software, software components, program codes, and/or instructions on one or more processors. The one or more processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more processors may enable execution of multiple programs, threads, and codes. The threads may be executed simultaneously to enhance the performance of the one or more processors and to facilitate simultaneous operations of the application. Program codes, program instructions and the like described herein may be implemented in one or more threads. The one or more processors may include memory that stores codes, instructions and programs as described herein. The processor may access a non-transitory processor-readable storage medium through an interface that may store codes, instructions and programs as described herein and elsewhere. The non-transitory processor-readable storage medium associated with the processor for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A game program product comprising a computer-readable program embodied on a non-transitory computer-readable storage medium, the computer-readable program, when executed by a computer, to cause a computer to perform at least:
controlling a display device to display a path indicator on a screen of the display device, the path indicator indicating a path on which a tracing operation should be made during a prescribed operating time period from a prescribed starting time until a prescribed ending time,
wherein controlling the display device comprises controlling the display device to gradually display the path indicator on the screen in accordance with a length of the prescribed operating time period.

2. The game program product according to claim 1, wherein controlling the display device to gradually display the path indicator is started from an appearance time before the prescribed starting time.

3. The game program product according to claim 1, wherein controlling the display device to display the path indicator comprises controlling the display device to display the path indicator to gradually extend with a speed in accordance with the length of the prescribed operation time period, from a starting point of the path indicator to an ending point of the path indicator.

4. The game program product according to claim 3, wherein controlling the display device to display the path indicator comprises controlling the display device to display the path indicator gradually on the screen with such a speed that an elapsed time from the starting point to the ending point of the path indicator is the same as the prescribed operation time period.

5. The game program product according to claim 1, wherein the computer-readable program, when executed by the computer, is to cause the computer to perform further:
accepting an operation with respect to the path indicator from a user; and
determining whether the operation accepted is in success or failure.

6. A game device comprising:
circuitry configured to at least: control a display to gradually display a path indicator on a screen of the display device, the path indicator indicating a path on which a tracing operation should be made during a prescribed operating time period from a prescribed starting time until a prescribed ending time.

7. The game device according to claim 6, wherein the circuitry is configured to further at least:
accept an operation with respect to the path indicator from a user; and
determine whether the operation accepted by the acceptor is in success or failure.

8. The game device according to claim 6, wherein the circuitry is configured to start controlling the display device to gradually display the path indicator from an appearance time before the prescribed starting time.

9. The game device according to claim 6, wherein the circuitry is configured to control the display device to display the path indicator to gradually extend with a speed in accordance with the length of the prescribed operation time period, from a starting point of the path indicator to an ending point of the path indicator.

10. The game device according to claim 9, wherein the circuitry is configured to control the display device to display the path indicator gradually on the screen with such a speed that an elapsed time from the starting point to the ending point of the path indicator is the same as the prescribed operation time period.

11. A game control method comprising:
controlling, by a computer, a display to gradually display a path indicator on a screen of the display device, the path indicator indicating a path on which a tracing operation should be made during a prescribed operating time period from a prescribed starting time until a prescribed ending time;
accepting, by the computer, an operation with respect to the path indicator from a user; and
determining, by the computer, whether the operation accepted by the acceptor is in success or failure.

12. The game control method device according to claim 11, wherein controlling the display device to gradually display the path indicator is started from an appearance time before the prescribed starting time.

13. The game control method according to claim 11, wherein controlling the display device to display the path indicator comprises controlling the display device to display the path indicator to gradually extend with a speed in accordance with the length of the prescribed operation time period, from a starting point of the path indicator to an ending point of the path indicator.

14. The game control method according to claim 11, wherein controlling the display device to display the path indicator comprises controlling the display device to display the path indicator gradually on the screen with such a speed that an elapsed time from the starting point to the ending point of the path indicator is the same as the prescribed operation time period.
